(19) United States
(12) Patent Application Publication
(10) Pub. No.: US 2022/0230207 A1
(43) Pub. Date: Jul. 21, 2022

(54) SYSTEM AND METHODS FOR SERVICE PROVIDER IDENTIFICATION

(71) Applicant: Robert RIVERA, Montgomery Village, MD (US)

(72) Inventor: Robert RIVERA, Montgomery Village, MD (US)

(21) Appl. No.: 17/580,597

(22) Filed: Jan. 20, 2022

Related U.S. Application Data
(60) Provisional application No. 63/139,502, filed on Jan. 20, 2021.

(51) Int. Cl. G06Q 30/02; G06Q 30/06; G06Q 30/00

(52) U.S. Cl. CPC G06Q 30/0282; G06Q 30/018; G06Q 30/0641

(57) ABSTRACT

The invention is that of systems and methods for individuals to identify service providers based on user-selected criteria and view the profiles of qualified service providers. The methods described herein allow users to have true and correct knowledge about the background and customer satisfaction associated with the service providers. Users may also upload recommendations based on experience with the service providers. Service providers may create profiles that allow users to understand their areas of competence, experience and other useful information for the selection process. Video and other content may be uploaded in support of service provider recommendations. A graphical user interface may be provided for ease of service provider vetting and selection, as well as interactivity between providers and other users. The systems and methods herein enable a high-quality service provider selection experience using social media and presentation concepts that does not exist in the current state of the art.

### CROSS-REFERENCE TO RELATED APPLICATION

The present application claims priority to and the benefit of U.S. Provisional Patent Application 63/139,502, filed Jan. 20, 2021, the entire contents of which are incorporated herein by reference.

### BACKGROUND OF THE INVENTION

Current web-based solutions for identifying providers of skilled or unskilled services such as home repairs, mechanical repairs and maintenance, landscaping, catering, personal assistance, hauling, ride-sharing and the like are rife with the risks associated with deceptive tactics executed over the Internet. Many websites that purport to offer such solutions have high failure rates among their customer bases due to a lack of knowledge about the backgrounds and effectiveness of unvetted service providers marketing themselves on such platforms. This poses not only risks attendant to customer satisfaction and value, but also safety risks associated with strange persons entering customers' properties, which can lead to injuries to property and person. The system and methods of the present disclosure provides a value-add solution that takes into account background checks as well as the personal histories, attributes and referral sources of service providers and customers alike in order to reduce these risks.

### BRIEF SUMMARY OF THE INVENTION

A system and methods of use thereof according to the present invention address a long felt need in the art by enabling individuals seeking service providers to identify providers that are more likely than not an excellent match for their needs. A system as described herein is designed to provide users with true and correct knowledge about the background and customer satisfaction associated with many service providers offering services on a platform comprising such a system. The invention of the present disclosure enables methods of referral of service providers, including but not limited to by: sending a link to a recommended service provider's profile; automatically sending a short message service (SMS) text message; automatically emailing the individual seeking service; and linking to service provider social media sites.

A platform as described herein, in preferred embodiments, has the attributes of social medial platforms familiar to those of ordinary skill in the art, as well as Internet and software application users at large. The platform is dedicated to a high-quality referral service that enables the pairing of service providers with customers, and indeed one another as may be the case. A website or downloadable software application according to certain embodiments of the invention described herein eliminates the conjecture associated with selecting service providers and provides a vetted, community-based method to qualifying providers. The system enables methods of high-quality, low-risk selection of the same, avoiding the drawbacks one might experience by browsing on “bulletin board” sites as will be familiar to one of ordinary skill in the art, such as Craigslist®, searching for business cards, relying on word-of-mouth referrals or overpaying for services.

Service providers are able to enter their information into the system securely and create visible profiles on a website or mobile application in certain embodiments of a system and methods as described herein. From there, user friendly profiles may be created and categorized, including such features, for example and not by way of limitation, as profile pictures, vetted customer ratings, appointment availability times, services offered, geographic coverage areas, licenses held, biographies, years in business, and confirmed numbers of clients receiving similar services as those offered according to the methods described herein.

Customers may then refer service providers using various means such as hyperlinks to provider profile pages (which may contain links to external provider websites), email, SMS text messaging directly to other users of the system. The system enables the referral of preferred providers by other users as well as the receipt of such referrals.

In one embodiment, a system as described herein comprises a database on a database server, the database comprising service provider information, i.e., name, location, business hours, services provided, background information and the like. A system of the present disclosure may also include additional servers, for example, a web server, a file server, and an email or phone relay server. A web host as one of ordinary skill in the art will appreciate may host a Uniform Resource Locator (URL) that customers can use to access the various server information. In preferred embodiments, a system as described herein may include a firewall or equivalent means of security between the system servers and the Internet, thereby protecting the system against unauthorized access, hacking and the like.

Users such as service providers or persons seeking them may access the system via the URL and create profiles, post referrals, upload information, etc. A system according to the present disclosure may further comprise a software module in network communication with the database, wherein the software module includes instructions which when executed by a microprocessor cause the processor to convert the information into user friendly presentations or a provided GUI, such as on a website or mobile application, thereby enabling seamless selection of qualified service providers by customers carrying out one or more methods enabled by the system. All added profile information and referral information may be viewed via the GUI, which serves as an interactive platform for subscribers, customers, referrals and any other users of a system of the present invention, enabling the execution of the claimed methods. These and other advantages over the current state of the art will be evident to one of ordinary skill therein.

### BRIEF DESCRIPTION OF THE DRAWINGS

FIG. 1 illustrates an exemplary system according to an embodiment of the present disclosure.

FIG. 2 illustrates a landing page of a GUI according to the present disclosure.

FIGS. 3A and 3B illustrate registration and sign-in dialog boxes as presented on a GUI of the present disclosure.

FIG. 4A illustrates a form having several fields for listing basic business information as described below.

FIG. 4B illustrates a second form having several fields for listing additional business information as described below.

FIG. 4C illustrates additional form fields for users to supply business information as described below.

FIG. 4D illustrates a contact form to enable further communications as described below.

FIG. 5 illustrates a GUI for identifying service providers by type according the present disclosure.

FIG. 6 illustrates a GUI for adding reviews and making contact with service providers.

### DETAILED DESCRIPTION OF INVENTION

The invention of the present disclosure relates to a website where individual and corporate service providers alike can be identified by their customers based on referrals from others who have retained the services of such providers, as well as any other website subscriber in good standing. Such providers may offer skilled or unskilled services without limitation. Specific services may be identified through broad categories then narrowed to the specific offerings sought. Now follows a detailed description with reference to the accompanying drawings for illustrative purposes.

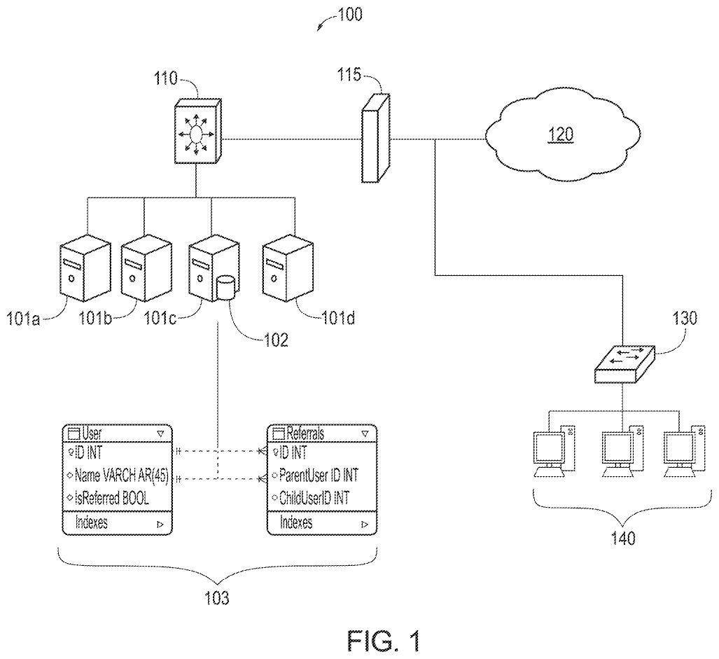

Beginning with FIG. 1, an embodiment of a system for service provider identification 100 as described herein may comprise one or more servers, such as but not limited to a web server 101a, file server 101b, database server 101c and email server 101d in communication with a web host 110, enabling a website according to the present disclosure to be viewed over a communications network 120, such as the Internet. A database server 101c may comprise a database 102 of service provider information and a web server 101a may further comprise a software module in communication with the database. A software module as described herein may be in the form of a downloadable software application or it may be web-based. A software module as described herein comprises instructions which when compiled and communicated to a connected microprocessor cause the microprocessor to generate displays of service provider profiles contained in the first database 102 based on service categories and other selected provider qualifications. A firewall 115 or equivalent may be provided in order to secure the various servers of a system as described in this paragraph.

Users of a system according to the present disclosure, such as but not limited to service providers and referring customers, may log in securely to a website from or download an application to a computing device 140, enabling users to seek service providers with the desired qualifications or make referrals based on customer experience. An application programming interface (API) 130 may exist between users of the system and the various system applications accessed over the Internet, for example. Users of a system as described herein may upload referrals to the system identifying their preferred service providers in selected areas based on past experience. Customers may also save their preferred service providers into a second database using a graphical user interface (GUI) 103 as are commonly understood in the art. A system as described herein enables secure service provider selection that is community-based and experience-based to ensure better outcomes in business transactions between service providers and their customers.

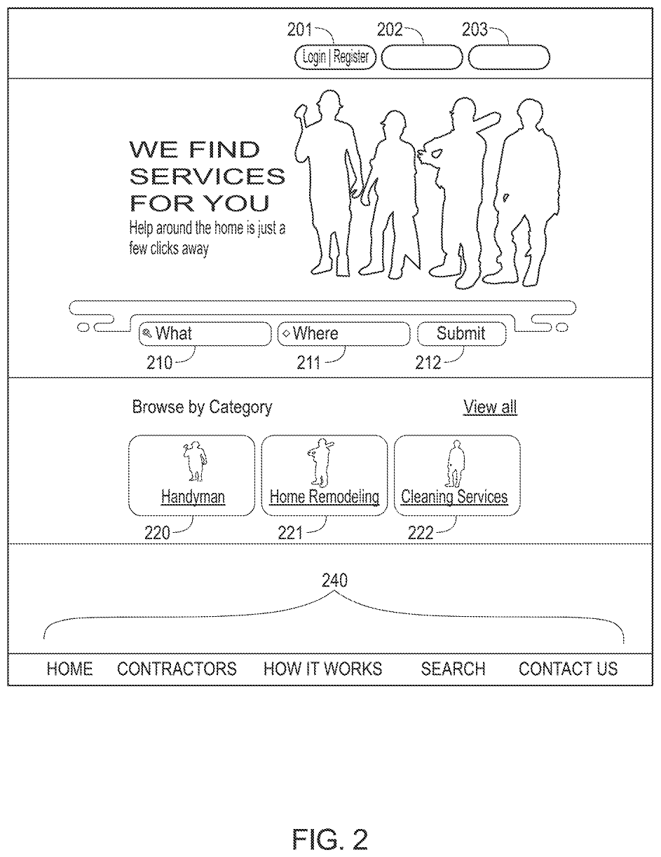

FIG. 2 illustrates a user view of a home page of a website or GUI usable with a mobile application according to the present disclosure. A navigation bar 240 may be provided for moving from page to page around the site or mobile app. In each case, a user may login/register, add a business or refer a contractor by actuating a graphic via mouse click or touch screen selected from 201, 202 and 203, respectively. In addition, text may be entered into fields 210 and 211 to enter the type of service needed and service location, respectively. Once the text is entered, the information is submitted at graphic 212, thereby causing a connected processor to execute instructions of a software module and thereby cause a display of database 102 information on the GUI corresponding to service providers within the vicinity of the service location.

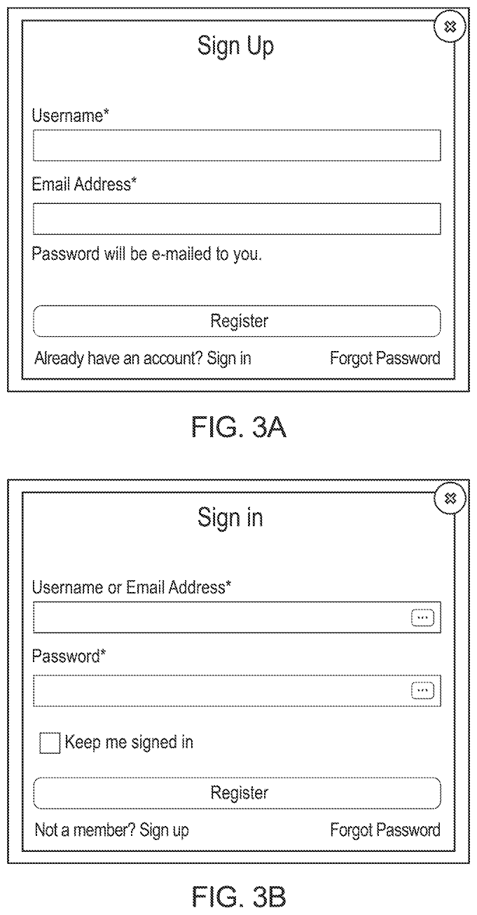

Exemplary registration and login screens are illustrated in FIGS. 3A and 3B, respectively. As will be familiar to one of ordinary skill in the art, a unique username and email address are typically requested by online platform providers using a dialog box such as that illustrated in FIG. 3A, with a one-time password (OTP) then emailed to the provided email address. A user will then typically enter and subsequently change the OTP to a password unique to the user, which the user can remember, by entering the requested information into a dialog box such as that shown in FIG. 3B.

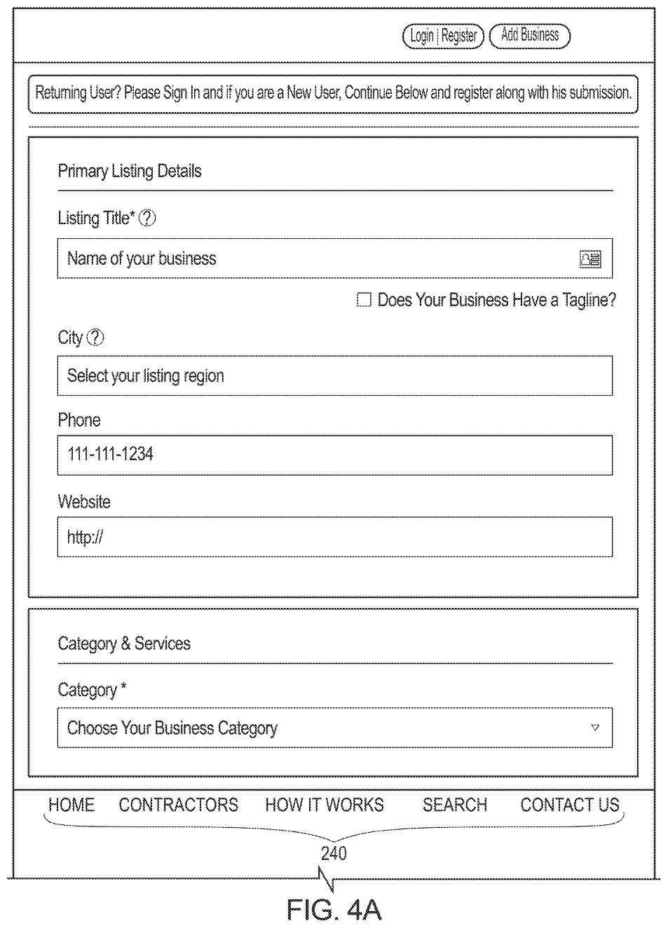

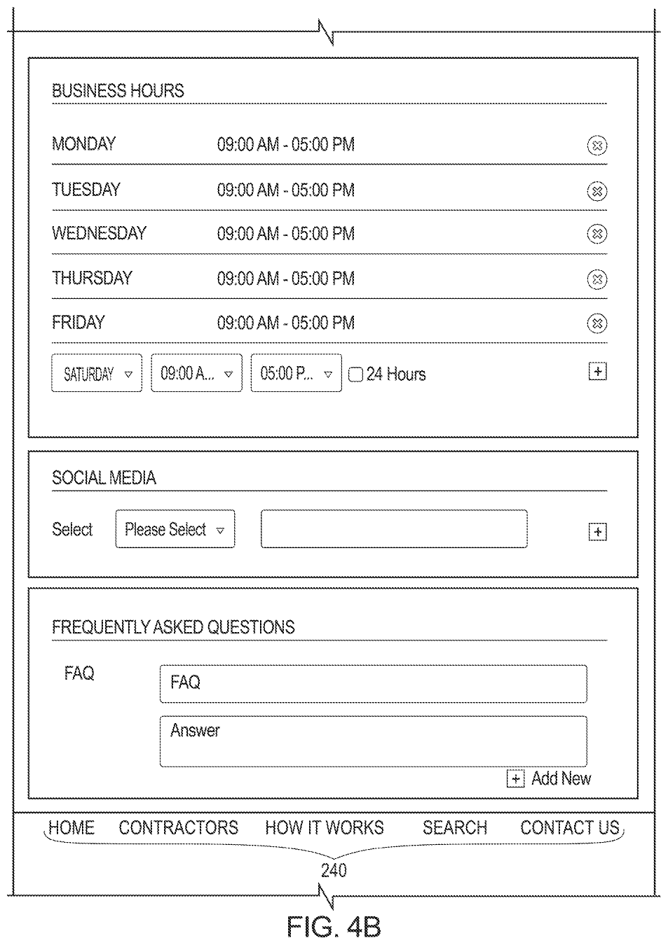

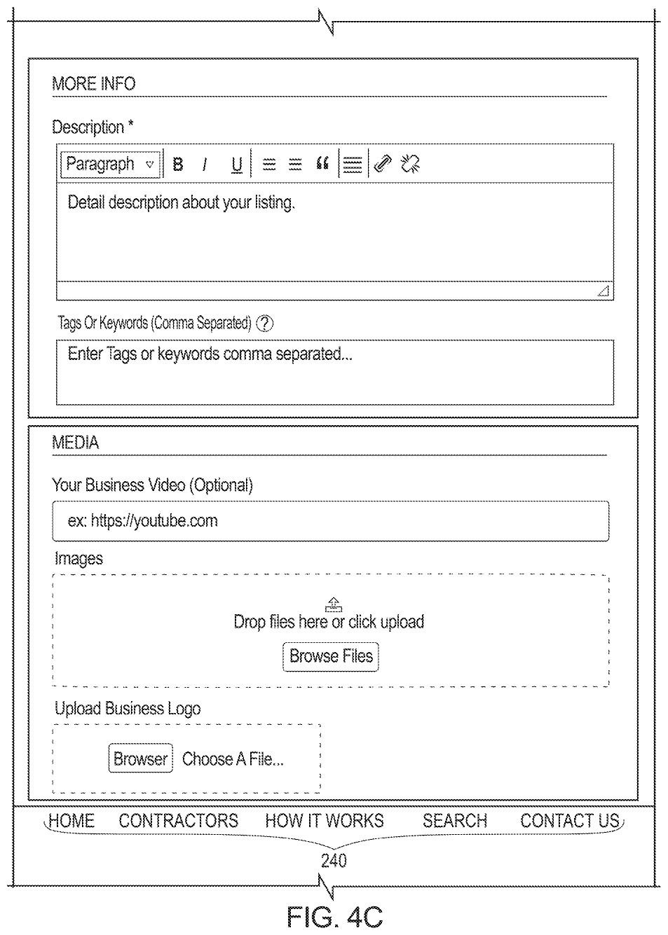

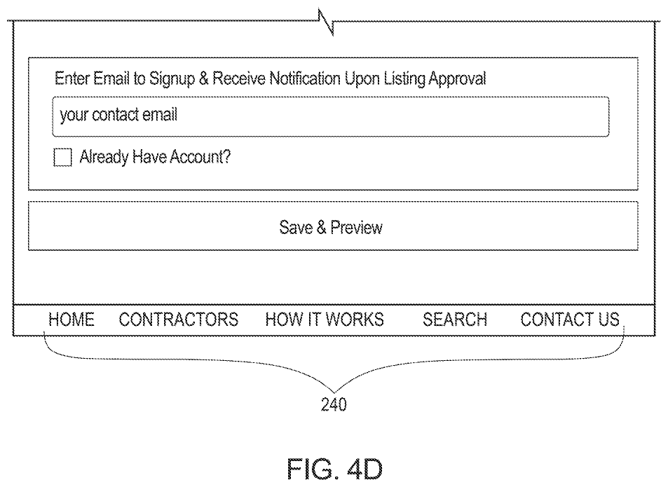

Turning now to FIG. 4A, service providers may create profiles and submit listings by registering an account and providing information to be identified by prospective customers. For example, service providers may enter a business name, location information, phone number, website URL and service category. Continuing into FIG. 4B, business hours, social media sites and other information may be displayed, all using form fields that will be familiar to one of ordinary skill in the art. An entry field for frequently asked questions may be provided where potential customers may make inquiries related to the service. Turning to FIG. 4C, additional details about the listing may be provided. Media such as video may also be uploaded or linked on the GUI, along with the uploading of image or other useful files to aid users in learning about the service offerings. At FIG. 4D, a service provider may enter contact information and be notified once approved. Once a service provider has developed a profile, other users may recommend that provider by sharing the profile to other prospects, linking to a website or social media site, and so on.

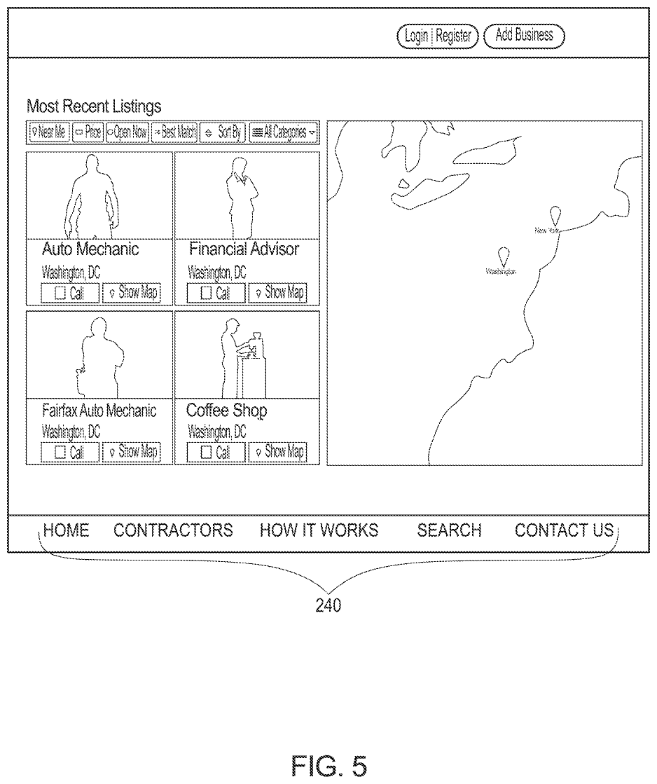

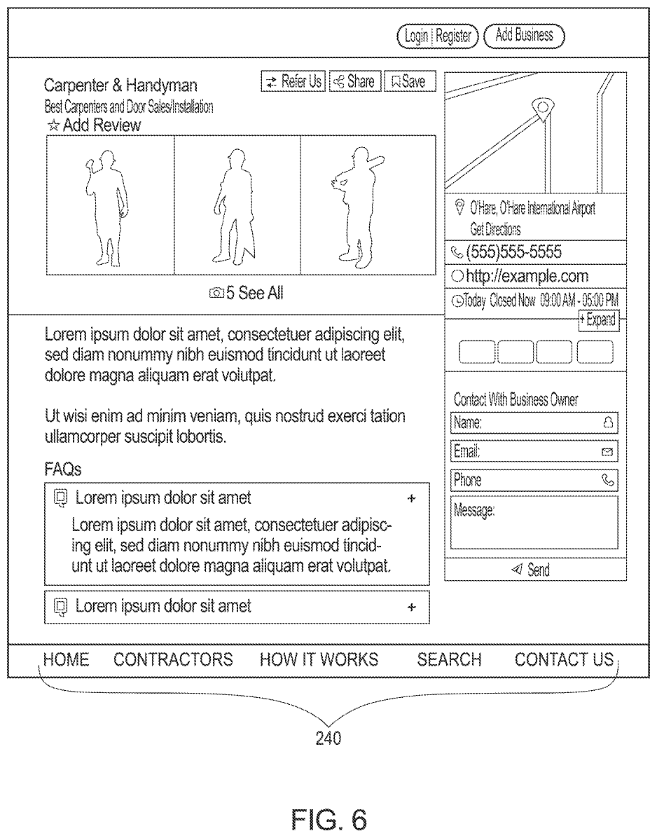

Turning now to FIG. 5, a GUI according to the present disclosure may offer the feature of enabling users to sort through providers by category. In this illustrative example, auto mechanic, financial advisor, and coffee shop service providers are shown. The GUI may also be configured with a map feature, shown to the right, where the provider locations may be displayed by interfacing with a mapping application. In each case users may sort service providers by price, location and other attributes as will be familiar to one of ordinary skill in the art. FIG. 6 shows a representative display example of a service provider's information, where users can add reviews, refer the provider, share the provider's profile with others, ask questions or send a message. Location, phone number, website URL and other information may be displayed and expanded for ease of use, as shown to the right.

The methods enabled by the present disclosure fulfill a long felt need in the art for a platform whereby people in need of various types of service providers may identify and select providers based on location, community recommendations and responses to specific questions from prospective customers. As shown in FIG. 2, users may add a business 202 or refer a contractor 203. Prospective customers may find contractors by selecting what type of service is needed and where (210-212) or browse by category (220-222), and view results identifying service providers that have been rated by the community at large and allowing connection to their profiles for service requests. Provider profiles make visible information supplied such as via web forms (FIGS. 4A-4D) which can be extremely useful for customers in the selection process, as will be familiar to one of ordinary skill in the art. Providers can easily be mapped to geographic locations as shown in FIG. 5 for ease of selection. The invention leverages concepts of social media and web content with service provider selection platforms that lack such features. These and other concepts will be familiar to one of ordinary skill in the art.

What is claimed is:

1. A system for service provider identification, the system comprising:
a software application and a service provider database, each tangibly stored on a non-transitory computer readable medium and in network communication with the other;
a computing device in network communication with the software application via an application programming interface (API) over a web host, the computing device having a graphical user interface (GUI) enabling a user to cause a processor to execute instructions of the software application;
wherein upon execution of the instructions, the software application queries the database and retrieves service provider information stored thereon based on criteria selected by the user.

2. A method for service provider identification, the method comprising:
causing a processor, via a GUI computing device over a connected API and web host, to execute instructions of a software application in network communication with a service provider database, which when executed cause the processor to query a service provider database and retrieve service provider information stored thereon based on criteria selected by a user;
wherein the software application and service provider database are each tangibly stored on a non-transitory computer readable medium and in network communication with the other.
